(19) United States
(12) Patent Application Publication
(10) Pub. No.: US 2025/0379305 A1
(43) Pub. Date: Dec. 11, 2025

(54) ASYMMETRICAL BATTERY SEAL SYSTEM AND METHOD

(71) Applicant: Apple Inc., Cupertino, CA (US)

(72) Inventors: Fujia Wang, Santa Clara, CA (US); Rui Liu, Mountain View, CA (US); Tong Xie, Campbell, CA (US); Enbang Wang, San Lorenzo, CA (US); Adnan Raza, San Jose, CA (US); Xingxing Zhang, Sunnyvale, CA (US); Rajesh Kandibanda, Menlo Park, CA (US); Mark E Wilcox, Morgan Hill, CA (US)

(21) Appl. No.: 19/191,995

(22) Filed: Apr. 28, 2025

Related U.S. Application Data
(60) Provisional application No. 63/657,555, filed on Jun. 7, 2024.

(51) Int. Cl. H01M 50/186; F16J 15/06; H01M 50/105; H01M 50/14; H01M 50/178; H01M 50/184; H01M 50/193; H01M 50/198; H01M 50/55

(52) U.S. Cl. CPC H01M 50/186; F16J 15/06; H01M 50/105; H01M 50/14; H01M 50/178; H01M 50/184; H01M 50/193; H01M 50/198; H01M 50/55

(57) ABSTRACT

The present disclosure is directed to a battery including an asymmetrical tab sealant, which includes a stronger seal portion around a tab in a tab opening of an enclosure (e.g., pouch) of the battery towards a cup side of the battery, and a weaker seal portion around the tab in the tab opening of the enclosure towards a non-cup side of the enclosure. Various characteristics may be employed to generate the stronger seal portion and the weaker seal portion, such as material characteristics, melting temperature characteristics, thickness characteristics, and so on.

### CROSS-REFERENCE TO RELATED APPLICATIONS

This application claims priority to U.S. Provisional Application No. 63/657,555, filed Jun. 7, 2024, entitled “ASYMMETRICAL BATTERY SEAL SYSTEM AND METHOD,” which is incorporated by reference herein in its entirety for all purposes.

### BACKGROUND

The present disclosure relates generally to a battery seal. More specifically, the present disclosure relates to a battery seal that provides protection against device drop scenarios and over- pressurization scenarios.

Certain traditional batteries may be susceptible to a breach of a battery enclosure when a device in which the battery is disposed is dropped or otherwise experiences an undesirable physical disturbance. Additionally or alternatively, certain traditional batteries may be ineffective in venting gases from the battery enclosure due to over-pressurization within the battery enclosure. Accordingly, it is now recognized that improved batteries capable of blocking or mitigating negative effects associated with device drop scenarios and/or over-pressurization scenarios are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery includes a battery enclosure having a tab opening configured to receive a battery tab. The battery also includes a first seal portion configured to seal a first portion of the tab opening about the battery tab, where the first seal portion includes a first characteristic that enables a first mechanical strength of the first seal portion. The battery also includes a second seal portion configured to seal a second portion of the tab opening about the battery tab, where the second seal portion includes a second characteristic that enables a second mechanical strength of the second seal portion such that the second mechanical strength is greater than the first mechanical strength.

In another embodiment, a method includes forming a non-cup side of a battery enclosure of a battery and forming a cup side of the battery enclosure of the battery. The method also includes disposing a first seal portion on a first portion of a battery tab in a tab opening of the battery enclosure, where the first portion corresponds to the non-cup side of the battery enclosure, and where the first seal portion includes a first characteristic that enables a first mechanical strength of the first seal portion. The method also includes disposing a second seal portion on a second portion of the battery tab in the tab opening of the battery enclosure, where the second portion corresponds to the cup side of the battery enclosure, and where the second seal portion includes a second characteristic that enables a second mechanical strength of the second seal portion. The second mechanical strength is greater than the first mechanical strength.

In yet another embodiment, a battery includes a battery enclosure including a first tab opening configured to receive a first battery tab and a second tab opening configured to receive a second battery tab. The battery also includes a first seal configured to seal the first tab opening about the first battery tab, where the first seal includes a first strong portion and a first weak portion. The first strong portion and the first weak portion differ in size, shape, or material composition such that the first strong portion includes a greater mechanical strength, a greater melting temperature, or both relative to the first weak portion. The battery also includes a second seal configured to seal the second tab opening about the second battery tab, where the second seal includes a second strong portion and a second weak portion. The second strong portion and the second weak portion differ in size, shape, or material composition such that the second strong portion includes a greater mechanical strength, a greater melting temperature, or both relative to the second weak portion.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a schematic perspective view of a battery employed to power the electronic device of FIG. 1, where the battery includes a battery enclosure, a battery tab opening in the battery enclosure, a battery tab extending through the battery tab opening, and an asymmetrical tab seal configured to seal the battery tab opening about the battery tab, according to embodiments of the present disclosure;

FIG. 3 is a perspective view of a battery, such as the battery of FIG. 2, where aspects of the asymmetrical tab seal are selectively located relative to a cup side of the battery enclosure and a non-cup side of the battery enclosure, according to embodiments of the present disclosure;

FIG. 4 is a cross-sectional view of an asymmetrical tab seal, such as the asymmetrical tab seal of the battery in FIG. 3, having a first seal portion (e.g., a weak seal portion) and a second seal portion (e.g., a strong seal portion) disposed on opposing sides of the battery tab, according to embodiments of the present disclosure;

FIG. 5 is a perspective view of the asymmetrical tab seal of FIG. 4, according to embodiments of the present disclosure; and

FIG. 6 is a process flow diagram illustrating a method of manufacturing a battery having an asymmetrical tab seal, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system- related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure is directed to a battery with improved seal and venting capability. In particular, presently disclosed embodiments include a battery with an asymmetrical battery seal, referred to in certain embodiments of the present disclosure as an asymmetrical tab seal, configured to improve a performance of the battery in (or against) multiple scenarios, such as an unexpected drop scenario and/or an over-pressurization scenario (e.g., thermal runaway event). In the unexpected drop scenario, an integrity of a battery enclosure of the battery is desirable to prevent breach of the battery enclosure and subsequent leakage of electrolyte and other materials from the battery enclosure. Conversely, in an over-pressurization scenario, an efficient venting of gases is desirable to release internal battery pressure and heat.

A relatively weak seal may be preferable for venting in an over-pressurization scenario. A relatively strong seal may be preferable for protecting the integrity of the battery enclosure in a drop scenario. Traditional battery seal configurations may prioritize one of these factors to the detriment of the other. Embodiments of the present disclosure include features configured to protect the battery against both drop scenarios and the over-pressurization scenarios, as described in detail below.

Proposed in the present disclosure is an asymmetrical battery seal, referred to in certain instances of the present disclosure as an asymmetrical tab seal, which includes a first portion and a second portion that together seal an opening in the battery enclosure, such as a tab opening configured to receive a battery tab (e.g., battery terminal) of the battery. The first portion may include characteristics that enable a relatively weak seal, such that the first portion enables a venting of gases from the battery enclosure and through the opening (e.g., the tab opening) in response to over-pressurization within the battery enclosure. The second portion may include characteristics that enable a relatively strong seal, such that the second portion is not breached during device drop scenarios and the integrity of the battery enclosure is protected. As used herein, the term “strong seal” indicates that the first seal may be characterized by a relatively greater mechanical strength (e.g., at room temperature) while the term “weak seal” indicates that the second seal may be characterized by a relatively lesser mechanical strength (e.g., at room temperature). The first portion and/or the second portion may be selectively located in the opening (e.g., the tab opening) of the battery enclosure such that areas of the opening more susceptible to breach during drop scenarios are protected by the second portion (e.g., the relatively strong portion) of the seal. Various characteristics may be employed to generate the first seal portion (e.g., relatively weak seal portion) and the second seal portion (e.g., relatively strong seal portion), such as material characteristics, melting temperature characteristics, thickness characteristics, and so on. It should be noted that reference to “asymmetrical tab seal” or “asymmetrical seal” does not necessarily denote asymmetry in shape, though in some instances, the relatively weak seal portion and the relatively strong seal portion may be asymmetrical in shape. Indeed, the tab seal(s) may be referred to as asymmetrical due to differences in size, shape, materials, or other characteristics. These and other aspects of the present disclosure are described in detail below.

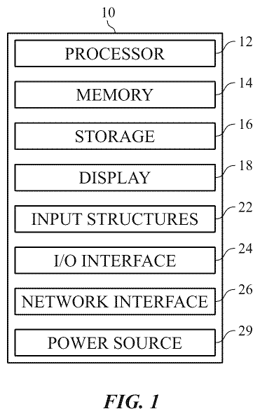

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth). The power source 29 of the electronic device 10 may include any suitable source of power, such as a rechargeable lithium polymer (Li-poly) battery, a rechargeable lithium-ion (Li-ion) pouch battery, some other type of secondary or rechargeable battery, and/or an alternating current (AC) power converter.

In accordance with the present disclosure, and as described in detail below with reference to later drawings, a battery (e.g., corresponding to the power source 29) of the electronic device 10 includes an asymmetrical battery seal (e.g., asymmetrical tab seal) configured to seal an opening in a battery enclosure (e.g., a housing) of the battery, where the asymmetrical battery seal improves a performance of the battery in device drop scenarios and over-pressurization scenarios. For example, the battery may include a battery tab coupled to a battery electrode within the battery enclosure, a battery tab opening disposed in the battery enclosure and configured to receive the battery tab, and an asymmetrical tab seal configured to seal the battery tab opening about the battery tab, among other features. The asymmetrical tab seal may include a first seal portion (e.g., a relatively weak seal portion) configured to enable venting of gases from the battery in response to the over-pressurization scenarios, and a second seal portion (e.g., a relatively strong seal portion) configured to protect an integrity of the battery enclosure, including the asymmetrical tab seal, in drop scenarios. The first and second portions of the symmetrical tab seal may be selectively located to ensure that the battery enclosure is not breached during device drop scenarios, and such that venting is enabled during over-pressurization scenarios. These and other aspects of the present disclosure are described in detail below.

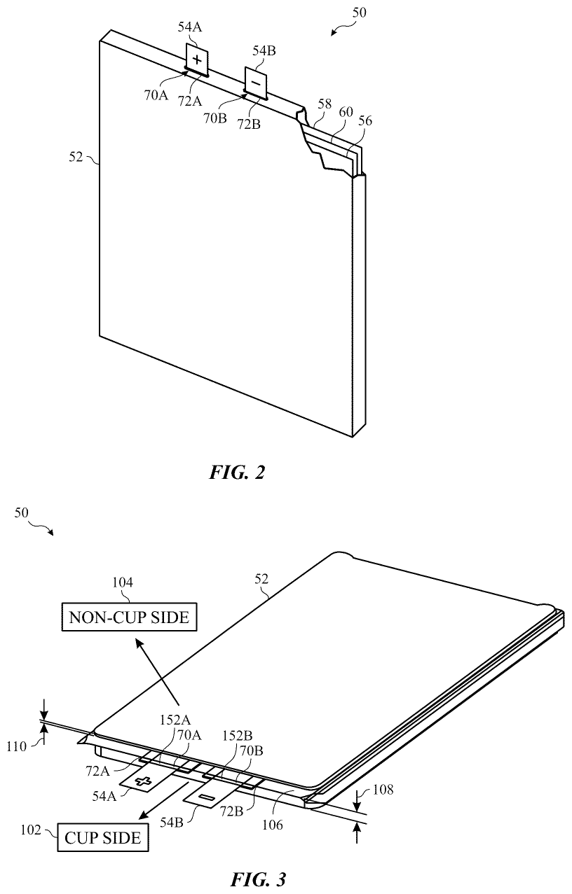

FIG. 2 is an illustration of a battery 50 of the electronic device 10 discussed above with respect to FIG. 1 (e.g., where the battery 50 corresponds to the power source 29). The battery 50 may include a battery enclosure 52 (e.g., a battery housing), a cathode tab 54A (e.g., a first battery tab corresponding to at least one cathode 56) and an anode tab 54B (e.g., a second battery tab corresponding to at least one anode 58). Collectively, the cathode tab 54A and the anode tab 54B may be referred to as the battery tabs 54.

As illustrated, the cathode 56, the anode 58, and a separator 60 between the cathode 56 and the anode 58 are disposed within the battery enclosure 52. In some embodiments, multiple instances of the cathode 56, the anode 58, and/or the separator 60 are disposed within the battery enclosure 52. Although the battery enclosure 52 is depicted as a rectangular prism in FIG. 2, it should be appreciated that in alternative or additional embodiments, the battery enclosure 52 may have any other viable form (e.g., shape and/or size). Indeed, in certain embodiments, the battery enclosure 52 may be a pouch, a casing, or the like that is pinched or otherwise closed around the cathode 56, the anode 58, and the separator 60 of the battery 50. The cathode 56, the anode 58, and the separator 60 may be referred to as an electrode assembly of the battery 50. The separator 60 (e.g., a single separator) is depicted as being disposed between the anode 58 and the cathode 56. For example, the cathode 56, the anode 58, and the separator 60 may be stacked and/or coupled together by any viable means. The cathode 56 may include phosphate and/or a metal oxide in certain embodiments, and the anode 58 may include graphite and/or silicon in certain embodiments.

The cathode 56 is disposed on a first side of the separator 60 and the anode 58 is disposed on a second side of the separator 60, as shown. The anode 58 may include anode active material, as previously described, that contributes to the electrochemical processes for storing energy or power. In some embodiments, the anode active material is coated or otherwise disposed on a portion of an anode current collector such that the anode tab 54B of (or coupled to) the anode current collector is exposed (e.g., uncoated or uncovered by the anode active material). The anode tab 54B may act as an electrical conductor between the anode 58 and external circuitry. In particular, the anode tab 54B may receive and/or output at least a portion of the electrical power or current between the anode 58 and external circuitry. The external circuitry may include the processor 12, the memory 14, the storage 16, the display 18, the input structures 22, the I/O interface 24, or the network interface 26 discussed above with respect to FIG. 1, or any combination thereof, among other things.

The cathode 56 may include cathode active material, as previously described, that contributes to the electrochemical processes for storing energy or power. In some embodiments, the cathode active material is coated or otherwise disposed on a portion of a cathode current collector such that the cathode tab 54A of (or coupled to) the cathode current collector is exposed (e.g., uncoated by the cathode active material). The cathode tab 54A may act as an electrical conductor between the cathode 56 and the external circuits. In particular, the cathode tab 54A may receive and/or output at least a portion of the electrical power or current between the cathode 56 and external circuitry. As mentioned above, the external circuitry may include the processor 12, the memory 14, the storage 16, the display 18, the input structures 22, the I/O interface 24, or the network interface 26 discussed above with respect to FIG. 1, or any combination thereof, among other possible componentry.

As shown, a first battery tab seal 70A (e.g., first asymmetrical battery tab seal) is configured to seal an opening 72A (e.g., battery tab opening) in the battery enclosure 52 through which the cathode tab 54A extends, and a second battery tab seal 70B (e.g., second asymmetrical battery tab seal) is configured to seal an opening 72B (e.g., battery tab opening) in the battery enclosure 52 through which the anode tab 54B extends. The first battery tab seal 70A and the second battery tab seal 70B may each include a first seal portion (e.g. relatively weak seal portion) and a second seal portion (e.g. relatively strong seal portion). The first seal portion is configured to enable an efficient venting from the battery enclosure 52 in response to over-pressurization within the battery enclosure 52. The second seal portion is configured to maintain a seal in response to device drop scenarios or other undesirable physical disturbances.

In certain embodiments, the second seal portion of the first battery tab seal 70A and the second seal portion of the second battery tab seal 70B are located in areas of the respective openings 72A, 72B that are more likely to be disturbed in a device drop scenario. In this way, the relative strength of the second seal portions is leveraged to protect an integrity of the battery enclosure 52 in a device drop scenario. Additionally or alternatively, the first seal portion of the first battery tab seal 70A and the first seal portion of the second battery tab seal 70B are located in areas of the respective openings 72A, 72B that are less likely to be disturbed in a device drop scenario. In this way, the relative weakness of the first seal portions is leveraged to enable venting from the battery enclosure 52 in over-pressurization scenarios while reducing a likelihood of breach in the first seal portions during device drop scenarios. These and other aspects of the first battery tab seal 70A (e.g., first asymmetrical battery tab seal) and the second battery tab seal 70B (e.g., second symmetrical battery tab seal) are described in greater detail below with reference to later drawings.

FIG. 3 is an illustration of a battery, such as the battery 50 of FIG. 2, where the battery 50 is a pouch battery and the battery enclosure 52 of the battery 50 includes a cup side 102 and a non-cup side 104. For example, the battery enclosure 52 may include a relatively soft pouch that receives electrolyte and one or more electrode assemblies, among other possible componentry, where the pouch is pinched along a perimeter thereof to enclosure the electrolyte and the one or more electrode assemblies therein. Accordingly, the battery enclosure 52 includes a pinched portion 106 where the cup side 102 of the battery enclosure 52 extends from one side of the pinched portion 106 and the non-cup side 104 of the battery enclosure 52 extends from an opposing side of the pinched portion 106. The cup side 102 may include a first thickness 108 that is greater than a second thickness 110 of the non-cup side 104, attributable to the electrode assembly residing mostly in the cup side 102 of the battery enclosure 52.

As previously described, the battery 50 may include the first battery tab seal 70A surrounding the cathode tab 54A (e.g., within the opening 72A) and the second battery tab seal 70B surrounding the anode tab 54B (e.g., within the opening 72B). As described in greater detail below, the first battery tab seal 70A and the second battery tab seal 70B each include first seal portions 152A and 152B (e.g., relatively weak seal portion), respectively, adjacent to the non-cup side 104 of the battery enclosure 52 and second seal portions (e.g., relatively strong seal portion) adjacent to the cup side 102 of the battery enclosure 52. The second seal portions (e.g., relatively strong seal portion) are not shown in FIG. 3 due to the illustrated perspective, but will be illustrated in and described in greater detail with reference to later drawings. While the battery 50 is illustrated as having an asymmetrical enclosure including the cup side 102 and the non-cup side 104, it should be noted that the battery tab seals 70A, 70B (e.g., asymmetrical tab seals) may be implemented in any type of battery enclosure. For example, an asymmetrical tab seal may be utilized for a symmetrical battery enclosure having two cup sides or two non-cup sides, for a battery enclosure of a different type (e.g., prismatic batteries, cylindrical batteries, etc.). Moreover, an asymmetrical tab seal may be utilized for batteries of any shape, such as a rounded pouch battery. Further, it should be noted that “asymmetrical tab seal” or “asymmetrical seal” may be employed to denote differences in size, shape, materials, or other characteristics of two or more portions of each such seal.

In the device drop scenario, the integrity of the battery enclosure 52 may be desirable to prevent leakage of electrolyte and other harmful materials. Conversely, in an over- pressurization scenario, an efficient venting of gases from the battery enclosure 52 may be desirable to release internal battery cell pressure to prevent negative effects of over-pressurization. The first seal portions 152A, 152B (e.g., relatively weak seal portions) may be preferable for venting in an over-pressurization scenario. Further, the first and second battery tab seals 70A, 70B may be less likely to be breached in a device drop scenario at the non-cup side 104 than at the cup side 102. Accordingly, the first seal portions 152A, 152B (e.g., relatively weak seal portion) may be located at the non-cup side 104 such that, while it enables efficient venting as outlined above, it is less likely to be impacted by drop scenarios or other physical disturbances. On the other hand, the second seal portion (e.g., relatively strong seal portion), which is not shown in FIG. 3 due to the illustrated perspective, may be disposed along the cup side 102 of the battery enclosure 52, as the cup side 102 may be more likely to be impacted by drop scenarios or other physical disturbances. By tuning the positions of the first and second seal portions of each of the battery tab seals 70A, 70B, the battery 50 is better protected against device drop and over-pressurization scenarios.

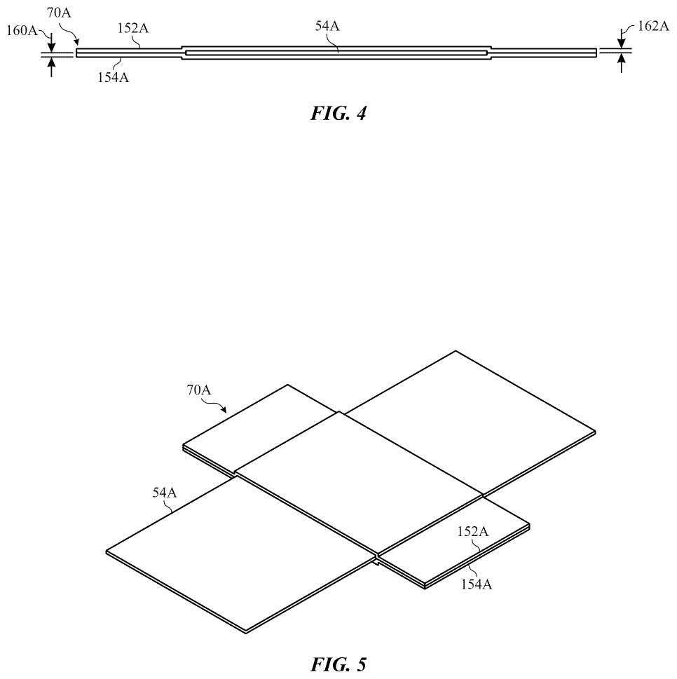

FIG. 4 is a perspective view of the battery tab seal 70A (e.g., asymmetrical battery tab seal) having the first seal portion 152A (referred to below as a relatively weak seal portion) illustrated in FIG. 3 and a second seal portion 154A (referred to below as a relatively strong seal portion) disposed on opposite sides of the cathode tab 54A, according to embodiments of the present disclosure. It should be understood that the battery tab seal 70A illustrated in FIG. 4 may include the same or similar properties as the second battery tab seal 70B illustrated in FIGS. 2 and 3. The relatively weak seal portion 152A, the relatively strong seal portion 154A, or both in the illustrated embodiment may include polypropylene material as well as chemical additives to give the relatively weak seal portion 152A and the relatively strong seal portion 154A desirable characteristics. However, a material composition of the relatively weak seal portion 152A may differ from a material composition of the relatively strong seal portion 154A in certain embodiments. For example, an amount or type of the polypropylene material and/or an amount or type of the chemical additives may differ between the relatively weak seal portion 152A and the relatively strong seal portion 154A. In general, a first material composition of the relatively weak seal portion 152A may facilitate a weaker seal than a second material composition of a relatively strong seal portion 154A.

Referring to features illustrated across FIGS. 3 and 4, the relatively weak seal portion 152A may be disposed on the non-cup side 104 of the battery enclosure 52 and the relatively strong seal portion 154A may be disposed on the cup side 102 of the battery enclosure 52. The relatively weak seal portion 152A may break in response to over-pressurization, enabling the battery 50 to release internal gas and protect against negative effects associated with over-pressurization. The relatively weak seal portion 152A may be associated with certain characteristics, such as a lower melting point relative to the relatively strong seal portion 154A. For example, the melting point of the relatively weak seal portion 152A may range below 130 degrees Celsius. The relatively weak seal portion 152A may or may not include a similar thickness 162A as 160A of the relatively strong seal portion 154A in certain embodiments. That is, the thickness 162A of the relatively weak seal portion 152A may be less than or substantially equal to the thickness 160A of the relatively strong seal portion 154A. The melting point of the relatively weak seal portion 152A may enable the relatively weak seal portion 152A to breach more easily (e.g., during over-pressurization scenarios).

Conversely, the relatively strong seal portion 154A may be associated with certain characteristics such as a greater melting point relative to the weak seal portion 152A. For example, the melting point of the relatively strong seal portion 154A may be equal to or above 130 degrees Celsius. Further, as previously described, the second thickness 160A of the relatively strong seal portion 154A may be greater than (or substantially equal to) the first thickness 162A of the relatively weak seal portion 152A, enabling a greater mechanical strength and/or higher melting temperature of the relatively strong seal portion 154A than of the relatively weak seal portion 152A. Other characteristics enabling differential mechanical strength and/or melting temperature between the relatively weak seal portion 152A and the relatively strong seal portion 154A include a difference in surface enhancements, coatings, shape, other size characteristics, pores, etc.

FIG. 5 is a perspective view of the battery tab seal 70A (including the relatively weak seal portion 152A and the relatively strong seal portion 154A) disposed over the cathode tab 54A, according to an embodiment of the present disclosure. As may be appreciated, the battery tab seal 70A may be disposed so as to seal the cathode tab 54A into the opening 72A of the battery enclosure 52 illustrated in FIG. 3. As discussed above, the relatively weak seal portion 152A may be disposed such that the relatively weak seal portion 152A corresponds to the non-cup side 104 of the battery 50 and the relatively strong seal portion 154A corresponds to the cup side 102 of the battery 50. The relatively weak seal portion 152A and the relatively strong seal portion 154A may differ in material composition, or other characteristics as previously described, but may or may not differ in size and shape.

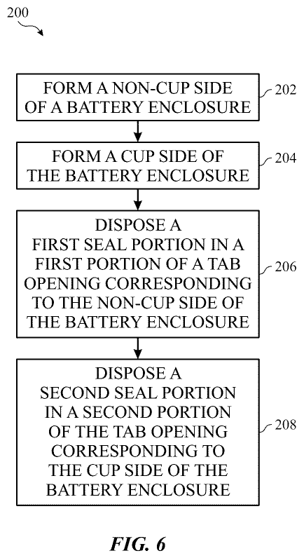

FIG. 6 is a process flow diagram illustrating a method 200 of manufacturing batteries in any of FIGS. 2-5 described above. It should be appreciated that the method 200 may be performed in any viable order. Moreover, it should be appreciated that in different embodiments, the method 200 may include additional and/or reduced process blocks.

The method 200 includes forming (block 202) a non-cup side of a battery enclosure. The method 200 also includes forming (block 204) a cup side of the battery enclosure. The cup side may include a greater thickness than the non-cup side. Indeed, in certain embodiments, one or more electrode assemblies may reside mostly within the cup side of the battery enclosure. As previously discussed, while the method 200 includes forming the non-cup side and the cup side of the battery enclosure, it should be noted that the asymmetrical tab seal, described in greater detail below, may be utilized with any appropriate form of battery or battery enclosure.

The method 200 also includes disposing (block 206) a first seal portion (e.g., a relatively weak seal portion) in a battery tab opening of the enclosure and along a first portion of a battery tab (i.e., a first portion of a cathode tab or an anode tab). The method 200 also includes disposing (block 208) a second seal portion (e.g., a relatively strong seal portion) in the battery tab opening and along a second portion of the battery tab. By disposing the relatively weak seal portion over the first portion of the battery tab corresponding to the non-cup side of the battery enclosure, efficient venting of the batteries during an over-pressurization scenario may be provided. Additionally, by disposing the relatively strong seal portion over a second portion of the battery tab corresponding to the cup side of the battery enclosure, robust drop protection may be afforded to the batteries, reducing the likelihood that a drop may cause a breach in the battery enclosure.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function]. . . ” or “step for [perform] ing [a function]. . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery comprising:
a battery enclosure comprising a tab opening configured to receive a battery tab;
a first seal portion configured to seal a first portion of the tab opening about the battery tab, the first seal portion comprising a first characteristic that enables a first mechanical strength of the first seal portion; and
a second seal portion configured to seal a second portion of the tab opening about the battery tab, the second seal portion comprising a second characteristic that enables a second mechanical strength of the second seal portion such that the second mechanical strength is greater than the first mechanical strength.

2. The battery of claim 1, wherein the first characteristic comprises a first melting point, the second characteristic comprises a second melting point, and the second melting point is greater than the first melting point.

3. The battery of claim 2, wherein the first melting point is below 130 degrees Celsius.

4. The battery of claim 2, wherein the second melting point is at least 130 degrees Celsius.

5. The battery of claim 1, wherein the first characteristic comprises a first thickness, the second characteristic comprises a second thickness, and the second thickness is greater than the first thickness.

6. The battery of claim 1, wherein the first characteristic comprises a first material composition, the second characteristic comprises a second material composition, and the second material composition is different than the first material composition.

7. The battery of claim 1, wherein the first portion of the tab opening corresponds to a non-cup side of the battery enclosure.

8. The battery of claim 1, wherein the second portion of the tab opening corresponds to a cup side of the battery enclosure.

9. The battery of claim 1, wherein the first seal portion, the second seal portion, or both comprises polypropylene.

10. The battery of claim 1, comprising electrodes disposed in the battery enclosure and electrically coupled with the battery tab, wherein the electrodes comprise:
a first electrode having phosphate, a metal oxide, or both; and
a second electrode having graphite, silicon, or both.

11. A method comprising:
forming a non-cup side of a battery enclosure of a battery;
forming a cup side of the battery enclosure of the battery;
disposing a first seal portion on a first portion of a battery tab in a tab opening of the battery enclosure, wherein the first portion of the battery tab opening corresponds to the non-cup side of the battery enclosure, and wherein the first seal portion comprises a first characteristic that enables a first mechanical strength of the first seal portion; and
disposing a second seal portion on a second portion of the battery tab in the tab opening of the battery enclosure, wherein the second portion of the battery tab opening corresponds to the cup side of the battery enclosure, and wherein the second seal portion comprises a second characteristic that enables a second mechanical strength of the second seal portion such that the second mechanical strength is greater than the first mechanical strength under room temperature.

12. The method of claim 11, wherein the first characteristic comprises a first thickness and the second characteristic comprises a second thickness.

13. The method of claim 11, wherein the first characteristic comprises a first material composition, the second characteristic comprises a second material composition, and the second material composition is different than the first material composition.

14. The method of claim 11, wherein the first seal portion, the second seal portion, or both comprise polypropylene.

15. The method of claim 11, wherein the first characteristic comprises a first melting point, the second characteristic comprises a second melting point, and the second melting point is greater than the first melting point.

16. The method of claim 11, wherein the battery comprises a lithium-ion pouch battery.

17. A battery comprising:
a battery enclosure comprising a first tab opening configured to receive a first battery tab and a second tab opening configured to receive a second battery tab;
a first seal configured to seal the first tab opening about the first battery tab, wherein the first seal comprises a first strong portion and a first weak portion, and wherein the first strong portion comprises a greater mechanical strength, a greater melting temperature, or both relative to the first weak portion; and
a second seal configured to seal the second tab opening about the second battery tab, wherein the second seal comprises a second strong portion and a second weak portion, and wherein the second strong portion comprises a greater mechanical strength, a greater melting temperature, or both relative to the second weak portion.

18. The battery of claim 17, wherein the battery enclosure comprises a cup side and a non-cup side, wherein the first strong portion and the second strong portion are disposed along the cup side of the battery enclosure, and wherein the first weak portion and the second weak portion are disposed along the non-cup side of the battery enclosure.

19. The battery of claim 17, wherein the first battery tab comprises a cathode battery tab, and the second battery tab comprises an anode battery tab.

20. The battery of claim 17, comprising:
a first electrode disposed in the battery enclosure and electrically coupled with the first battery tab, wherein the first electrode comprises phosphate, a metal oxide, or both; and
a second electrode disposed in the battery enclosure and electrically coupled with the second battery tab wherein the second electrode comprises graphite, silicon, or both.
